(19) United States
(12) Patent Application Publication
(10) Pub. No.: US 2016/0134342 A1
(43) Pub. Date: May 12, 2016

(54) Adaptive MIMO Feasibility feedback

(71) Applicant: Nokia Technology Oy, Espoo (FI)

(72) Inventors: Jarkko KNECKT, Espoo (FI); Toni HUOVINEN, Pirkkala (FI); Olli ALANEN, Vantaa (FI)

(21) Appl. No.: 14/890,265

(22) PCT Filed: May 23, 2013
(86) PCT No.: PCT/IB2013/054281

§ 371 Date: Nov. 10, 2015

(51) Int. Cl. H04B 7/04

(52) U.S. Cl. CPC H04B 7/0452; H04B 7/0456; H04B 7/0417

(57) ABSTRACT

In accordance with an example embodiment of the present invention, an apparatus comprises a processor and a memory including computer program code, wherein the memory and the computer program code, with the processor, are configured with the processor to cause the apparatus to receive a reference signal (302), estimate difference between actual Eigen directions and precoding matrix based on the received reference signal (304), generate a feedback based on the result of the estimation (306), and transmit the feedback (38), wherein the feedback indicates at least one of the result of the estimation, whether a multi-user communication mode is desired or whether the feedback should be combined with another indication in order to determine whether a multi-user communication mode is desired (306). Methods and computer readable media are also described.

### TECHNICAL FIELD

The exemplary and non-limiting embodiments relate generally to wireless communication systems, methods, devices and computer programs and, more specifically, to data transmission in multi-user multiple-input and multiple-output (MU-MIMO) networks.

### BACKGROUND

A wireless communication system may contain multi-antenna transmitter(s) and multi-antenna receiver(s), also called MIMO, in both uplink and downlink. One cellular network system, referred to as the 3rd generation partnership project (3GPP) work item on the Long Term Evolution (LTE), also known as the Evolved Universal Terrestrial Radio Access Network (E-UTRAN) is an example of wireless MIMO system. Another example of MIMO system is wireless local area network (WLAN), standardized as IEEE 802.11ac, referred to as a wireless computer networking standard of IEEE 802.11. In a circumstance of multiple users in a downlink of a wireless MIMO system, such system will be called MU-MIMO system if transmitters are capable of multiplexing two or more users spatially into same time-frequency resource.

The E-UTRAN provides for downlink peak rates of at least 100 megabits per second (Mbps) and for uplink peak rates of at least 50 Mbps. It supports scalable carrier bandwidths from 20 MHz down to 1.4 MHz and supports both Frequency Division Duplexing (FDD) as well as Time Division Duplexing (TDD). E-UTRAN aimed to provide high throughput, low latency, FDD and TDD support in the same platform, improved end user experience and a simple architecture resulting in low operating costs. Further releases of 3GPP LTE, for example LTE Rel-11 and Rel-12, are referred as LTE-Advanced (LTE-A), which extends and optimizes the 3GPP LTE radio access technologies.

The IEEE LAN/MAN Standards Committee created IEEE 802.11, a set of standards, for WLAN communication in 0.9, 2.4, 2.6, 5 and 60 GHz frequency bands. IEEE 802.11ac is one of those standards that provides high throughput WLAN on the 5 GHz frequency band. This particular standard is targeted to enable multi-station WLAN throughput of at least 1 Gbps and a maximum single link throughput of at least 500 Mbps.

### SUMMARY

The below summary section is intended to be merely exemplary and non-limiting.

Various aspects of examples of the invention are set out in the claims.

In a first aspect thereof an exemplary embodiment provides an apparatus comprising at least one processor and at least one memory including computer program code, wherein the at least one memory and the computer program code are configured, with the at least one processor, to cause said apparatus to receive a reference signal, estimate a difference between actual Eigen directions and a precoding matrix based on the received reference signal, generate a feedback based on the result of the estimation, and transmit the feedback, wherein the feedback indicates at least one of the result of the estimation, whether a multi-user communication mode is desired, or whether the feedback should be combined with another indication in order to determine whether a multi-user communication mode is desired.

In another aspect thereof an exemplary embodiment provides an apparatus comprising at least one processor and at least one memory including computer program code, wherein the at least one memory and the computer program code are configured, with the at least one processor, to cause said apparatus to transmit a reference signal, receive a feedback indicating at least one of a result of channel state estimation based on the transmitted reference signal, whether a multi-user communication mode is desired, or whether the feedback should be combined with another indication in order to determine whether a multi-user communication mode is desired, and determine whether to use a multi-user communication mode based on the received feedback.

In further aspect thereof an exemplary embodiment provides a method comprising receiving a reference signal, estimating a difference between actual Eigen directions and a precoding matrix based on the received reference signal, generating a feedback based on the result of the estimation, and transmitting the feedback, wherein the feedback indicates at least one of the result of the estimation, whether a multi-user communication mode is desired, or whether the feedback should be combined with another indication in order to determine whether a multi-user communication mode is desired.

In a another aspect thereof an exemplary embodiment provides a method comprising transmitting a reference signal, receiving a feedback indicating at least one of a result of channel state estimation based on the transmitted reference signal, whether a multi-user communication mode is desired, or whether the feedback should be combined with another indication in order to determine whether a multi-user communication mode is desired, and determining whether to use a multi-user communication mode based on the received feedback.

In another aspect thereof an exemplary embodiment provides a computer readable medium tangibly encoded with a computer program executable by a processor to perform actions comprising receiving a reference signal, estimating a difference between actual Eigen directions and a precoding matrix based on the received reference signal, generating a feedback based on the result of the estimation, and transmitting the feedback, wherein the feedback indicates at least one of the result of the estimation, whether a multi-user communication mode is desired, or whether the feedback should be combined with another indication in order to determine whether a multi-user communication mode is desired.

In another aspect thereof an exemplary embodiment provides a computer readable medium tangibly encoded with a computer program executable by a processor to perform actions comprising transmitting a reference signal, receiving a feedback indicating at least one of a result of channel state estimation based on the transmitted reference signal, whether a multi-user communication mode is desired, or whether the feedback should be combined with another indication in order to determine whether a multi-user communication mode is desired, and determining whether to use a multi-user communication mode based on the received feedback.

In another aspect thereof an exemplary embodiment provides an apparatus comprising means for receiving a reference signal, means for estimating a difference between actual Eigen directions and a precoding matrix based on the received reference signal, means for generating a feedback based on the result of the estimation, and means for transmitting the feedback, wherein the feedback indicates at least one of the result of the estimation, whether a multi-user communication mode is desired, or whether the feedback should be combined with another indication in order to determine whether a multi-user communication mode is desired.

In another aspect thereof an exemplary embodiment provides an apparatus comprising means for transmitting a reference signal, means for receiving a feedback indicating at least one of a result of channel state estimation based on the transmitted reference signal, whether a multi-user communication mode is desired, or whether the feedback should be combined with another indication in order to determine whether a multi-user communication mode is desired, and means for determining whether to use a multi-user communication mode based on the received feedback.

### BRIEF DESCRIPTION OF THE DRAWINGS

The foregoing and other aspects of exemplary embodiments are made more evident in the following Detailed Description, when read in conjunction with the attached Drawing Figures, wherein:

FIG. 1 illustrates an example of MU-MIMO transceiving in an LTE or LTE-A based network;

FIG. 2 illustrates an example of MU-MIMO transceiving in a WLAN based network;

FIG. 3 illustrates a flow chart of the generation of feedback from an UE or terminal to an eNB or AP;

FIG. 4 illustrates a flow chart of feedback being used for the determination of a single user or multi-user communication mode;

FIG. 5 illustrates another flow chart of feedback being used for the determination of a single user or multi-user communication mode;

FIG. 6 illustrates an example of VHT beamforming signaling; and

FIG. 7 illustrates an example of a simplified block diagram of exemplary electronic devices that are suitable for use in practicing various exemplary embodiments of this invention.

### DETAILED DESCRIPTION

MU-MIMO has been widely used in wireless networks. One example is it being used in an LTE or LTE-A system and another example is it being used in a WLAN system.

In one example of MU-MIMO systems, a transmitter which may be referred to as an access node, an access point, a network node, a base station, BS, an E-UTRAN Node B, evolved Node B or eNB, is allowed to spatially multiplex transmissions targeted to different receivers, for example, K receivers, which may be referred to as local area devices, user devices, mobile terminals, user equipments or UEs, on the same time-frequency resource.

Assuming the transmitter has Nₜ transmit antennas and the receivers have Nᵣ receive antennas. Then the received signal for the k-th receiver is

yₖ=HₖWs+nₖ,

where Hₖ is an Nᵣ×Nₜ MIMO channel matrix, W is a spatial precoding matrix and s is a vector of signals transmitted to spatially multiplexed users. In addition, nₖ is a noise-plus-external-interference vector. The external interference may include, for example, intercell interference in a cellular network, colliding transmissions in undetected carrier-sense-multiple-access (CSMA) based networks and etc.

The problem occurs when two or more receivers are co-scheduled for the same time-frequency resource or the same time-frequency unit. This problem is related to MIMO channel state information (CSI) feedback. Typically, MIMO CSI consists of two parts, spatial channel information and channel quality indication (CQI). We name it conventional CSI or conventional CSI feedback.

The spatial channel information indicates supported transmission rank, for example, the number of co-transmitted spatial streams targeted to report UE in an E-UTRAN, and information of Eigen channels, such as optimal spatial directions for co-transmitted streams. Based on the spatial channel information, the transmitter is able to precode transmission data streams spatially.

The CQI, on the other hand, indicates the post processing signal to interference plus noise ratio (SINR) value of a data stream at the receiver. Based on the CQI, the transmitter can perform link adaption and scheduling. In MU-MIMO communication mode, the post processing SINR at the receiver depends on multi-user precoding method and the co-scheduled receivers. The estimation of the post processing SINR for MU-MIMO communication mode is difficult because the receivers to be potentially co-scheduled are unknown at the CQI calculation stage.

There are two existing solutions to the problem of the MU-MIMO CQI feedback calculation. One is to have the UE, the receiver, estimate and report the post processing SINR under the assumption that no multi-user interference exists. The resulting SINR estimate is referred to as single user CQI. According to the single user CQI feedback sent from the UE, the BS, which could also be referred to as the transmitter earlier, will try to estimate the effect of multi-user operation and scale down the reported CQI values accordingly. This solution has been adopted in LTE-A as well as in WLAN.

The other solution is to have the UE estimate a multi-user post processing SINR prior to transmitting the MU-MIMO CQI feedback to the BS. Such estimation could be made based on some prior knowledge of potentially co-scheduled UEs. This solution has been studied by 3GPP, and it's found that gains of different methods implementing the solution are questionable. Additionally, these methods significantly increase the CQI feedback overhead, because single user CQI feedback is usually needed in order to perform dynamic switching between single user and multi-user operations.

The difference or the mismatch between single user and multi-user CQIs is mainly due to three causes. The first cause is sharing transmit power between co-scheduled UEs, which is trivial for the BS to compensate. The second cause is off-steering spatial transmit streams from the reported precoding directions, which is also known as spatial directions or spatial feedback derived or indicated by precoding matrix, in order to avoid unreasonable multi-user interference. This operation is commonly called zero forcing (ZF) precoding. Several proposals have been made to deal with the compensation of its effect.

It may be possible to derive actual multi-user CQI from reported single user CQI, by knowing the transmit power downscaling and the best Eigen directions of the spatially multiplexed UEs. This may be done by compensating the only source of difference between actual multi-user CQI and the down scaled single user CQI that comes from mismatch between the best Eigen direction of the UE and the steering direction resulting from ZF precoding, by assuming that Eigen receivers together with an ideal ZF beam forming cancel out multi-user interference from the received signal. “MIMO Downlink with Mode Switching”, published at the 13^{th} International Symposium on Wireless Personal Multimedia Communications (WPMC2010) by Helka-Liina Maattanen et al. further investigates this topic and shows that the multi-user specific SINR may be derived from the single user specific SINR with a simple scaling that depends only on the correlation between the preceding vectors of the users, when the preceding feedback is ideal. The scaling method may be introduced to the signal quality report. The scaling method, for example in “MIMO Downlink with Mode Switching”, introduced the ZF off-steering factor, which is used for single user CQI scaling when a ZF precoding is applied. The scaling, depending on the correlation between the precoding vectors of the users, enables the multi-user specific SINR to be derived from the single user specific SINR when the precoding feedback is acceptable.

Another paper titled “Performance Evaluations for Multiuser CQI Enhancements for LTE-Advanced” by Helka-Liina Maattanen et al., compared the performance of different multi-user CQI calculation method and concluded that it is difficult to distinguish a single outperforming CQI calculation method.

The third cause of the difference or mismatch between the single user and multi-user CQIs is multi-user interference due to inaccurate spatial feedback, for example, the best Eigen directions of the channel, ZF type precoding is supposed to guarantee multi-user interference-free reception, provided the use of so called “Eigen receiver”. In practice, however, the feedback is never ideal. At least, it is affected by quantization error, for example, error from averaging over block of sub frequency bands. Consequently, MU-MIMO always suffers from interference leakage between co-scheduled UEs. It is extremely difficult for the BS to estimate the amount of leakage interference in order to adjust reported CQI values, because it would require knowledge of the magnitude of error in the spatial feedback.

Nevertheless, UE can estimate the magnitude of difference between the actual spatial Eigen directions and the precoding directions or precoding matrix it reports as spatial feedback to BS. Since the difference is mainly due to the quantization and averaging performed by the UE itself, the following approaches may be taken.

The UE estimates the difference between actual Eigen directions and the precoding directions or precoding matrix it reports to the BS in terms of a suitable distance measurement. Then, the UE compares the difference to one or more predetermined or predefined thresholds and generates a feedback for the BS. The feedback may indicate the result of the estimation of the difference between actual Eigen directions and the precoding directions or precoding matrix. It is also possible that the feedback indicates whether a multi-user communication mode is desired. For example, it can indicate either a multi-user communication mode or a single user communication mode is desired, more suitable or preferred. The feedback may further indicate that the preference of the communication mode should be combined with another indication in order to determine whether a multi-user communication mode is desired or not. Finally, the UE signals this feedback to the BS as a feedback or an additional multi-user or single user feasibility feedback in additional to the conventional feedback such as the conventional CSI feedback.

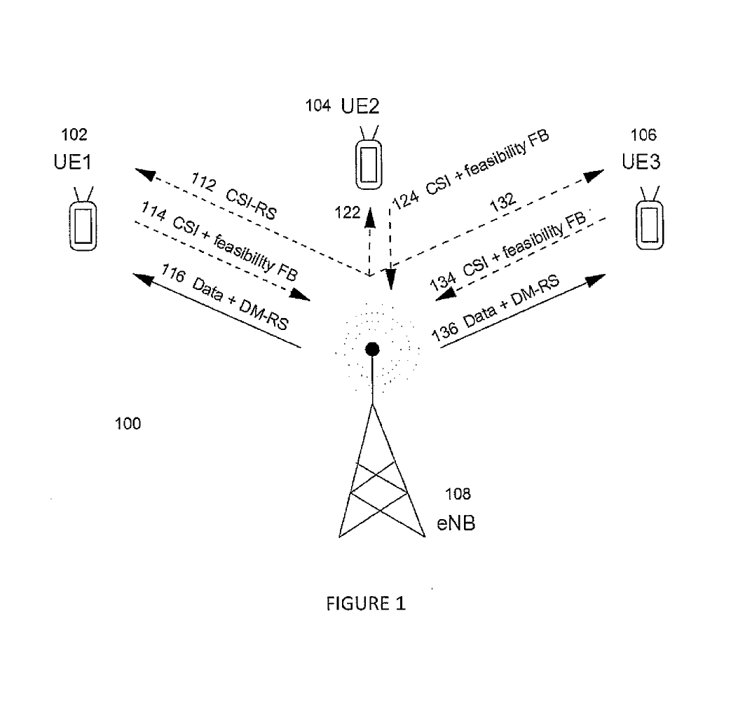

FIG. 1 illustrates an example of MU-MIMO transceiving in an LTE or LTE-A based network 100. The evolved nodeB (eNB) 108, which also referred as a base station or BS, transmits reference signals such as channel state information reference signals (CSI-RS) 112, 122 and 132 periodically within a downlink physical data shared channel (PDSCH) to the user equipments (UEs), UE1 102, UE2 104 and UE3 106, respectively. According to the current LTE specification, each UE estimates the spatial channel from the CSI-RS and periodically or aperiodically signals the state of their spatial channel, which is the conventional CSI feedback, back to eNB. The conventional CSI feedback consists of channel quality indicator (CQI), supported transmission rank indicator (RI) and precoding matrix index (PMI).

Adding some other feedback or additional feedback information will improve the accuracy of the feedback from the UEs to the eNBs. In other words, the additional feedback assists the eNB to make a better decision of the communication mode. The additional feedback, for example feasibility feedback, or multi-user feasibility feedback, may be included in the conventional CSI feedback or combined with the conventional CSI feedback 114, 124 and 134 to be transmitted from UE1 102, UE2 104 and UE3 106 respectively to eNB 108. The other feedback may indicate to the eNB 108 whether the feedback from UEs should be combined with another indication such as a zero-forcing off-steering factor, in order to determine whether either a multi-user communication mode or a single user communication mode is desired or preferred.

Based on the UEs' feedback, which may indicate that multi-user communication mode is desired or preferred, the eNB 108 determines the communication mode and schedules the UEs, for example, determining or selecting which UE or UEs it will transmit messages to and arranging resource for such transmission. In FIG. 1, UE1 102 and UE3 106 are the selected UEs. The eNB 108 also performs link adaptation, for example, selecting transmission parameters for the selected UEs. The eNB 108 transmits data and demodulation reference symbols (DM-RS) 116 and 136 to the scheduled or selected UEs, UE1 102 and UE3 106, respectively. In this case, UE2 104 is not selected for data transmission. Each UE may comprise at least one of a zero-forcing precoding and maximum ratio combiner receiver, a zero-forcing precoding and realistic linear minimum mean square estimator receiver, a unitary precoding and maximum ratio combiner receiver, or a unitary precoding and realistic linear minimum mean square estimator receiver.

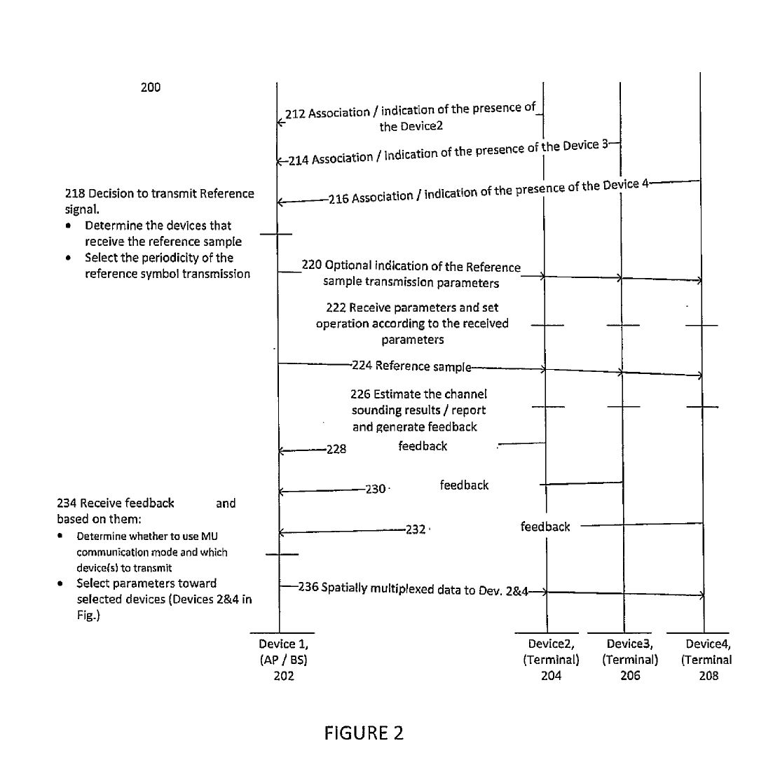

In FIG. 2, an example of MU-MIMO transceiving in a WLAN based network 200 is illustrated. Device1 202 is an access point (AP), also may be referred as a base station. Devices2 204, device3 206 and device4 208 are terminals, which may also be called users, user equipments, client devices, stations (STAs), etc. In step 212, terminal 204 sends an association or indication of the presence of itself to the AP 202, so that the AP becomes aware of the terminal's existence and its capability of multi-user communication mode, for example MU-MIMO transmission. Terminals 206 and 208 send the equivalent signals to the AP 202 in the same way in steps 214 and 216, respectively. The sequence of the transmission of the association signaling does not have to be in the order of 212, 214 and then 216 as shown in the drawing. The signalings from these three terminals may be sent at different times or at the same time.

In step 218, the AP 202 makes a decision on transmitting a reference sample, also called reference signal, reference symbol or RS. In IEEE 802.11ac, the reference sample is a null data packet (NDP). The AP 202 determines to which terminal(s) the reference sample is to be transmitted and the periodicity of the transmission of the reference sample, which indicates the frequency of the transmission of the reference sample.

The AP 202 may transmit an indication of the reference sample transmission parameters to each terminal 204, 206, 208 in step 220. The indication of the reference samples is optional. As an example of a frame for providing such an indication, the 802.11ac WLAN uses very high throughput (VHT) NDP announcement frame, which informs the terminal that it should receive the reference samples. Sometimes, the frame also indicates to the terminal when the terminal should report the estimation of the reference samples, namely a sounding feedback to the AP 202.

Consequently, the terminals 204, 206 and 208 receive the transmission parameters and set their operation according to the received parameters in step 222. The AP 202 transmits reference samples to each of the terminals 204, 206 and 208 in step 224. In the following step 226, each terminal measures the received reference samples and makes a channel state estimation, such as by estimating the channel sounding. Based on the result of the estimation, the terminals may generate feedback, which may indicate the result of the estimation or whether a multi-user communication mode is desired or the feedback should be combined with another indication to determine whether a multi-user communication mode is desired. Each terminal 204, 206, 208 transmits the feedback, also called the sounding feedback, to the AP 202, in steps 228, 230 and 232, respectively.

According to the received feedback from the terminals 204, 206, 208, in step 234, the AP 202 determines whether to use a multi-user communication mode. The AP 202 also determines or selects which terminal(s) to transmit and the parameters for transmission to the selected terminals, for example terminal 204 and 208 in FIG. 2. And, it further selects or adjusts the transmit parameters for the transmission to the selected terminals. Finally, in step 236, the AP 202 transmits spatially multiplexed data to the selected terminals 204 and 208.

The UE can estimate the precision of the precoding matrix, also called the spatial feedback, generate a feedback based upon the result of the estimation and signal the feedback to the eNB during the time that the UE estimates received reference signals and transmits the precoding matrix to the eNB. In other words, if precision of the precoding matrix changes, for example due to the UE's movement, the eNB may adapt to the changes accordingly.

There are various ways to measure the difference between actual Eigen directions and the precoding directions or precoding matrix which UE will signal to eNB as the spatial feedback. Assuming that the UE has estimated its spatial channel matrix Hₖ, determined supported transmission rank N_{RI}, obtained optimal Nₜ×N_{RI} precoding matrix Vₖ by calculating a singular value decomposition (SVD) of Hₖ and quantized and averaged Vₖ to Nₜ×N_{RI} spatial feedback matrix Cₖ. Basically, the UE must perform at least most of these operations in order to provide normal spatial feedback, according to the current LTE standard, to the eNB. In some cases, it is possible to determine supported rank and normal spatial feedback without explicit SVD calculation. The columns of matrixes Vₖ and Cₖ define the optimal and quantized versions of the N _{RI} best spatial Eigen directions, respectively. Various distance metrics d(Vₖ, Cₖ) have been introduced to measure difference between these two matrixes. The two most well-know distances are Chordal distance

$${d}_{chord} ( {V}_{k} , {C}_{k} ) = \frac{1}{\sqrt{2}} {‖ {V}_{k}^{H} {V}_{k} - {C}_{k}^{H} {C}_{k} ‖}_{Frobenius} ,$$

and Fubini-Studay distance,

d_{F-S}(Vₖ,Cₖ)=arccos|det(Vₖ^{H}Cₖ^{H})|.

The multi-user communication mode is often shown to outperform the single user communication mode when only one transmit stream is scheduled to each scheduled or co-scheduled UEs. In this case N_{RI}=1 and both of the above mentioned distances reduces to simple transformation of an inner-product between the dominant Eigen direction vector vₖ and its quantized counterpart cₖ:

d_{RI}(vₖ,cₖ)=\sqrt{1−|vₖ^{H}cₖ|²}.

Usually, frequency granularity of spatial feedback is relatively coarse, e.g., where one quantized feedback matrix Cₖ represents a block of frequency sub bands or even entire system bandwidth. In this case, a feedback precision metric Cₖ[j] for the j-th such block of sub bands is the average of the sub band distance metrics:

$${ρ}_{j} = {\sum }_{i ∈ {γ}_{j}} d ( {V}_{k} [ i ] , {C}_{k} [ j ] ) ,$$

where γⱼ is the set of sub band indexes belonging to the j-th sub band block and Vₖ[i] is an ideal spatial feedback matrix for sub band i ∈ γⱼ. Computational complexity can be decreased by considering only a subset of γⱼ for averaging.

Small distance metric values may be correlated to high Signal-to-MU-Interference-Ratio (SMUIR) values (representing a received power ratio between a UE's own spatial stream and leakage interference from co-scheduled streams) and vice versa. Hence, a UE can use a distance metric to determine whether MU operation is currently feasible or not. This can be done by setting a threshold value for the distance metric. The desired threshold may depend on which spatial precoding method (ZF, Unitary, etc.) is used, on the spatial receiver (such as, MRC, LMMSE, etc.) used and spatial channel characteristics. The threshold can be determined by measurements and/or simulations. The threshold can also be a predetermined value (such as a device-wise constant) based on the UE's spatial reception capabilities, 2) an adaptive value set based on the UE's spatial reception capabilities and channel measurements, or 3) an adaptive value negotiated between the UE and the BS (which may be based on the BS's precoding capabilities).

The feedback, which may also called the additional feedback, depends on the difference between actual Eigen directions and precoding matrix. Such feedback from the terminal (or the UE) to the AP (or the eNB) could be a single bit of information, “0” or “1”. For example, when the bit is set to “0”, the eNB is requested to operate in single user communication mode, such as because the multi-user interference leakage is estimated to be high. In this case, the single user communication mode is expected to outperform the multi-user communication mode. On the other hand, when single bit feedback is set to “1”, the multi-user interference leakage is estimated to be small or moderate, which means the multi-user communication mode is feasible.

Alternatively, the feedback can consist of multiple bits and characterizes the levels of the difference between the actual Eigen directions and the precoding matrix. For example, the UE reports to the eNB with two-bit feedback information, “00”, “01”, “10” and “11”, with each of them representing one of the four levels, for example, a very big difference, a rather big difference, a rather small difference and a very small difference. The feedback information of a very high difference between the actual Eigen directions and the precoding matrix would indicate to the eNB to switch to the single user communication mode and the feedback information of a very small difference would indicate that the multi-user communication mode will outperform the single user communication mode. If the UE feeds back an intermediate level of the difference, such as a rather high difference and a rather small difference, the BS may use this information together with another indication, such as a ZF off-steering factor, to make the decision of whether a multi-user communication mode is desired. The same principle may extend to the feedback with different numbers of feedback bits.

Another example of the multiple bits of feedback is where part of the feedback such as one or more bits of the feedback information may indicate whether the downlink and/or uplink multi-user communication mode is desired. The UE or STA may not desire or prefer to use the downlink multi-user communication mode, when the reception of the transmissions is not possible for it, when it does not desire to do sounding, or for some other reasons. In such circumstances, the feedback will indicate that the downlink communication mode is not desired. On the other hand, the uplink multi-user communication mode may limit the transmissions of the UE or STA. The UE or STA may be forced to have some data traffic for UL MU MIMO transmissions and it may not be allowed to obtain transmission opportunities. The UE or STA may communicate that it would like to transmit in single user communication mode in the uplink. Such feedback may be transmitted from the terminal to the eNB or AP alone. It may also be combined with the one-bit or two-bit feedback information introduced previously to be sent to the eNB or AP.

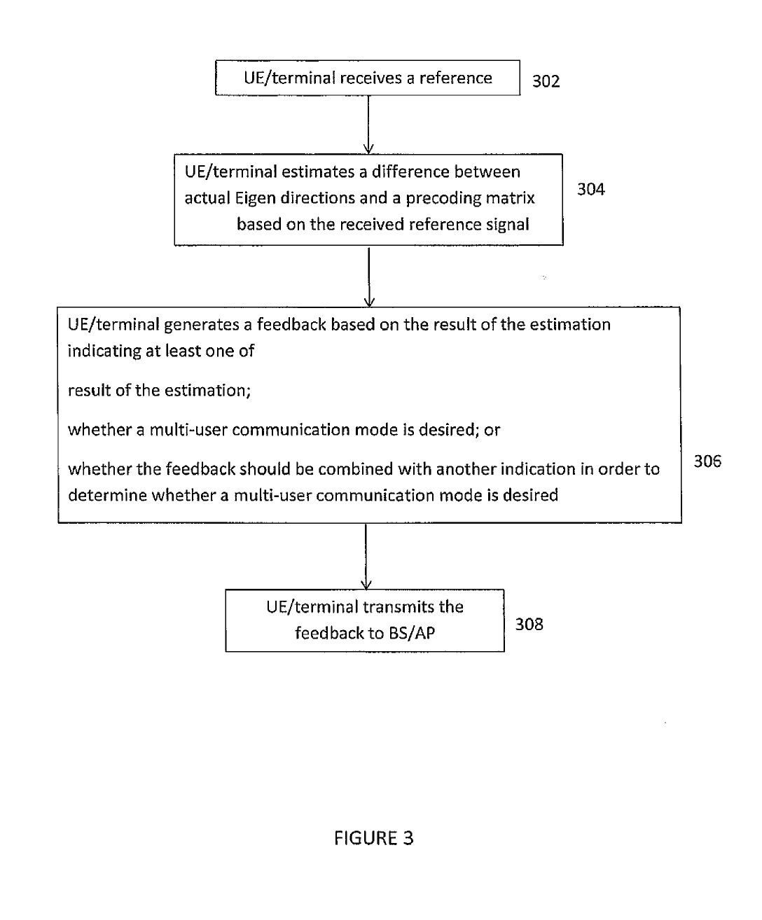

FIG. 3 illustrates a flow chart for the generation of feedback from a UE or terminal to an eNB or AP. A UE or terminal receives a reference signal, for example CSI-RS or reference sample, in step 302. Then, in step 304, it estimates the difference between the actual Eigen directions and the precoding matrix based on the reference signal. The precoding matrix is a spatial feedback sent to a network device, for example an eNB or an AP. The estimation may comprise calculating Chordal distance between the actual Eigen directions and the precoding matrix or calculating Fubini-Study distance between the actual Eigen directions and the precoding matrix.

There may be one or more predefined or preset thresholds, which the estimated difference will be compared with. If it is one threshold, the comparison result will be either the too big difference so that the multi-user communication mode is not acceptable, meaning it should not be used or is not desired and instead the single user communication mode is desired; or the difference is tolerable so that the multi-user communication mode should be used or is desired.

In step 306, the UE or the terminal generates feedback based on the result of the estimation, which indicates at least one of the result of the estimation, whether a multi-user communication mode is desired or whether the feedback should be combined with another indication in order to determine whether a multi-user communication mode is desired.

As an example, using a threshold for estimating the difference between the actual Eigen directions and the precoding matrix or precoding direction, the UE or terminal will generate a one-bit feedback in step 306, which may be either included as part of the CSI feedback or combined with the CSI feedback to be sent to the eNB or the AP. The one-bit feedback may be either one of the bits “0” or “1”. The feedback may further indicate at least one of whether downlink multi-user communication mode is desired or whether uplink multi-user communication mode is desired with some additional feedback bits.

A multiple bit feedback, particularly a two-bit information, may indicate one of the four cases with more than one predefined thresholds used for determining which case describes the difference between the actual Eigen directions and the precoding matrix. Case1, case2, case3 and case4 are defined for very big difference identified, rather big difference, rather small difference and very small difference, respectively. And, each of them may be indicated by one of the four information bits “00”, “01”, “11” and “10”. Case1 indicates that multi-user communication mode should not be used or desired. Case4 indicates that multi-user communication mode should be used or is desired. Case2 and case3 indicates that the additional multi-user feasibility feedback should be combined with another indication for the network device, for example a zero-forcing off-steering factor, in order to determine whether the multi-user operation should be used or not. This feedback indicates a utility of the directed transmission beam. Again, at least one more bit of feedback may further indicate at least one of whether a downlink or uplink communication mode is desired, or whether the additional downlink or uplink multi-user feasibility feedback should be taken into account with another indication such as a zero-forcing off-steering factor in order to determine whether the downlink or the uplink multi-user communication mode is desired.

Furthermore, for the feedback indication, the communication mode depends on the definition of each of the indications.

Then, in step 308, the UE or the terminal transmits the feedback to the eNB or the AP so that the eNB/AP can decide whether or not the multi-user communication mode should be used. The UE may comprise at least one of a zero-forcing precoding and maximum ratio combiner receiver, a zero-forcing precoding and realistic linear minimum mean square estimator receiver, a unitary precoding and maximum ratio combiner receiver, or a unitary precoding and realistic linear minimum mean square estimator receiver.

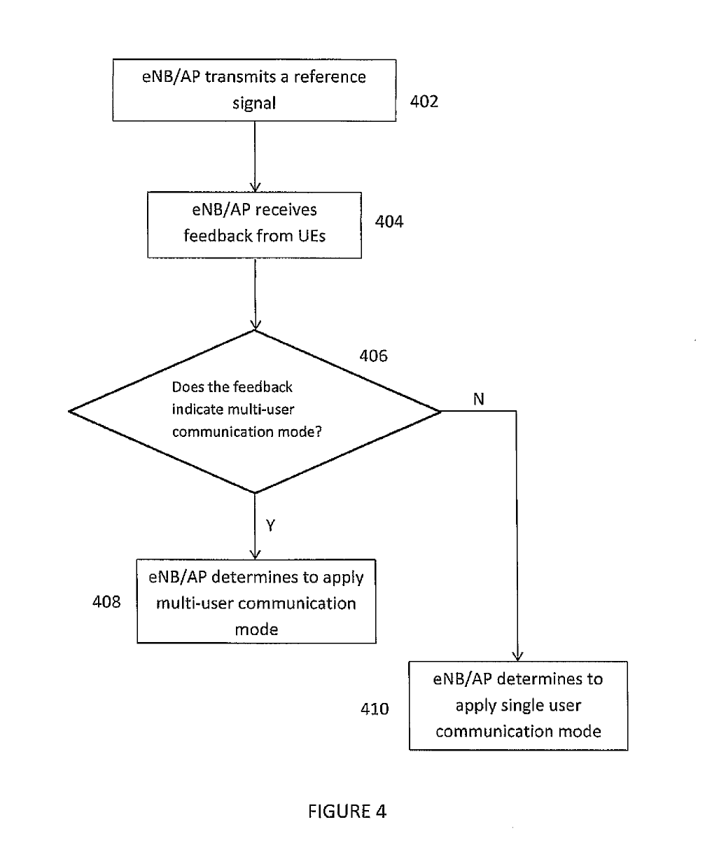

FIG. 4 illustrates a flow chart of feedback used for the determination of single user or multi-user communication mode. In 402, an eNB or AP transmits a reference signal, and it receives a feedback, in step 404, which may indicate at least one of the result of channel state estimation based on the transmitted reference signal, whether a multi-user communication mode is desired or whether the feedback should be combined with another indication in order to determine whether a multi-user communication mode is desired. The result of a channel state estimation is generated based on the measurement of the reference signal received at a UE or a terminal.

The feedback can be a one-bit or a multiple bit information element, which may tell the eNB or the AP a multi-user or a single user communication mode is desired or preferred by the UE or the terminal. For example, in step 406, the eNB or the AP determines if the feedback indicates that a multi-user communication mode is feasible, desired or should be used.

If the feedback message indicates the feasibility of multi-user communication mode, the eNB or AP may just determine to apply the multi-user communication mode, in step 408. Otherwise, as shown in step 410, the eNB or AP may determine whether to apply a single user communication mode based on the feedback from the UE or terminal.

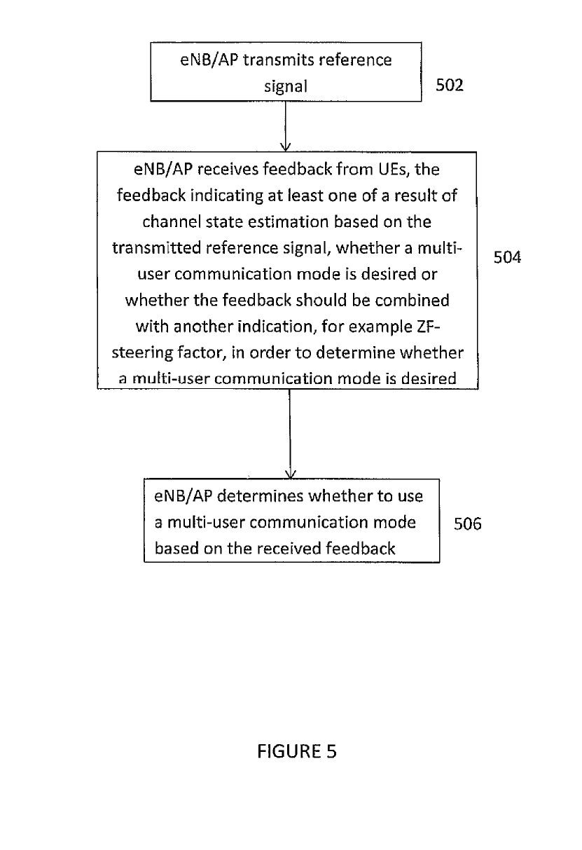

Another flow chart of feedback used for the determination of a single user or multi-user communication mode is shown in FIG. 5. An eNB or AP transmits a reference signal in step 502. The reference signal is used by a UE or terminal at least for estimating a difference between actual Eigen directions and precoding matrix, which is information not included in the conventional CSI feedback or the conventional sounding feedback generated by the UE or terminal for the eNB or AP. The feedback may further indicate a utility of the directed transmission beam.

In step 504, the eNB or AP receives feedback from the UEs. The feedback indicates at least one of a result of channel state estimation based on the transmitted reference signal, whether a multi-user communication mode is desired or whether the feedback should be combined with another indication, for example ZF off-steering factor, in order to determine whether a multi-user communication mode is desired.

The feedback may be a one-bit or multiple bit information element. In case of a one-bit feedback, the UE may indicate to the eNB either a multi-user or a single user communication mode is desired or feasible. If there are two bits used for the feedback information, which may be one of “00”, “01”, “11” and “10”, each two-bit feedback defines one of the four cases as described previously. Case1 is for very big difference between the actual Eigen directions and the precoding matrix the UEs used to report; case2 is for rather big difference, case3 is for rather small difference and case4 is for very small difference.

Based on the two-bit feedback information, the eNB or AP determines which case describes the additional multi-user feasibility feedback. As for easel, which indicates very big difference between the actual Eigen directions and the CSI feedback the UEs used to report, the eNB or AP will apply single user communication mode. Contrarily, for case4, the eNB or AP will use multi-user communication mode. As for the intermediate difference levels, cases 2 and 3, the eNB or AP will take another parameter, which may be a ZF off-steering factor, into account for the determination on the communication mode.

Following that, the eNB or AP determines in step 506 whether to use multi-user communication mode.

The feedback message in both FIG. 4 and FIG. 5 may also include the conventional CSI feedback which is generated based on the CSI-RS received by the user device. The CSI-RS is used by the user device at least for estimating difference between actual Eigen directions and precoding matrix. The precoding matrix is a spatial feedback from the user device. The estimation of the difference between actual Eigen directions and the precoding matrix may be performed by calculating a Chordal distance between the actual Eigen directions and the preceding matrix or by calculating a Fubini-Study distance between the actual Eigen directions and the preceding matrix.

The feedback discussed above is adaptive and it is not limited to any particular wireless system. Instead, it can be applied to any MU-MIMO capable closed-loop MIMO system. The format of the feedback may be system specific.

In an IEEE 802.11ac WLAN system, the UE, often referred as a terminal in WLAN, uses one or more bits of the MAC protocol data unit (MPDU) header to indicate the MU feasibility, which may be namely the multi-user feasibility field. The value of this field may change per each transmitted PLCP protocol data unit (PPDU). The terminal may signal the field by using a very high throughput (VHT) compressed beamforming frame in the VHT sounding protocol.

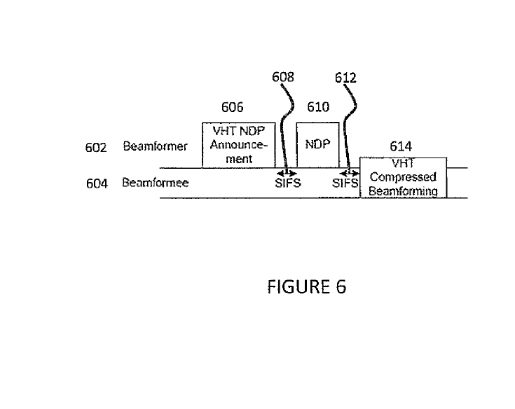

FIG. 6 illustrates an example of VHT beamforming signaling in an IEEE 802.11ac WLAN system. The beamformer 602 is typically a WLAN STA that is associated with an AP. The beamformer 604 is typically the AP. The VHT NDP Announcement frame or message 606 contains the address information that specifies the transmitter of the NDP and the devices that will respond with the VHT Compressed Beamforming packets 614. The NDP Announcement 606 also communicates the type and/or the preciseness of the feedback. Two Short Interframe Spaces (SIFS) 608 and 612 are small time intervals between the VHT NDP Announcement frame and a NDP frame and between the NDP frame and the VHT Compressed Beamforming frames. The NDP 610 contains just the PHY headers, including training fields and the PLCP header. The NDP 610 does not include any MAC header or data payload. Training sequences inside the training fields are used to calculate the beam steering parameters. The VHT Compressed Beamforming frame 614 contains the beam steering parameters. The terminal may use VHT compressed beamforming frame 614 to also signal the value of the multi-user feasibility field or the multi-user communication mode.

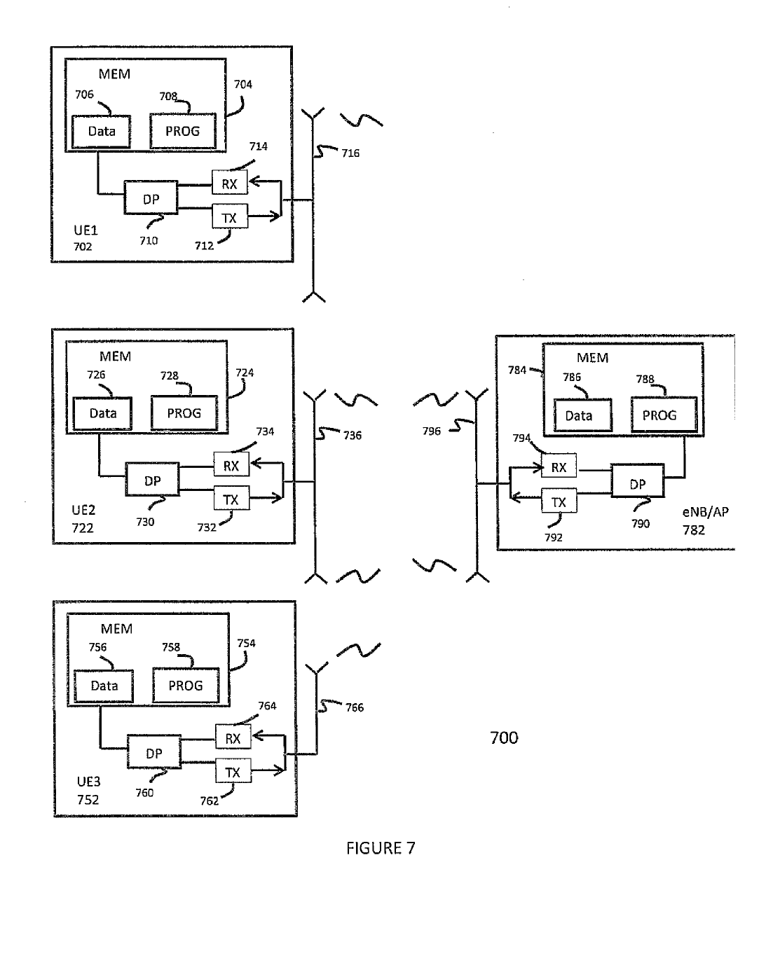

Reference is now made to FIG. 7, an illustration of an example of a simplified block diagram of example electronic devices that are suitable for use in practicing various example embodiments of this invention. In FIG. 7, a wireless system 700 is adapted for communication between UEs and an eNB or AP 782. UE1 702, UE2 722 and UE3 752 represent two or more UEs to whom the eNB's transmissions are spatially multiplexed and they need not to be identical.

The eNB 782 is adapted for communication over a wireless link with one or more apparatuses, such as mobile devices, mobile stations, mobile terminals or UEs 702, 722 and 752. The eNB 782 may be an access point, an access node, a base station, or an eNB similar to eNB 108 of FIG. 1, AP 202 of FIG. 2, and the eNB/APs discussed with FIG. 3, FIG. 4 and FIG. 5, wherein an eNB may comprise a frequency selective repeater, of any wireless network such as LTE, LTE-A, GSM, GERAN, WCDMA, CDMA, Wireless LAN, and the like. It is commonly found that one or more UEs are under the control of an eNB such as eNB 782. For simplicity, three UEs, UE1 702, UE2 722 and UE3 752, are shown in FIG. 9 as an example of a multi-user communication mode, and UE1 702 will be discussed in detail.

The UE1 702 may be a user device similar to the UE1, 2 and 3 in FIG. 1, devices 2, 3 and 4 in FIG. 2, and UEs discussed in FIG. 3, FIG. 4 and FIG. 5. The reason that UEs and an eNB are both illustrated here is that one convenient mechanism for carrying out embodiments of the present invention usually involves communication using a communication network.

The UE1 702 includes processing means such as at least one data processor, DP 710, storing means such as at least one computer-readable memory, MEM 704, for storing data 706, at least one computer program, PROG 708, or other set of executable instructions, and communication means such as a transmitter, TX 712, and a receiver, RX 714, for bidirectional wireless communications with the eNB 782 via one or more antenna 716, which is two antennas shown in FIG. 7 for bidirectional MU-MIMO communication between the UE and the eNB 782. Similarly, UE2 722 includes processing means such as at least one data processor, DP 730, storing means such as at least one computer-readable memory, MEM 724, for storing data 726, at least one computer program, PROG 728, or other set of executable instructions, and communication means such as a transmitter, TX 732, and a receiver, RX 734 and UE3 752 includes processing means such as at least one data processor, DP 760, storing means such as at least one computer-readable memory, MEM 754, for storing data 756, at least one computer program, PROG 758, or other set of executable instructions, and communication means such as a transmitter, TX 762, and a receiver, RX 764.

The eNB 782 also includes processing means such as at least one data processor, DP 790, storing means such as at least one computer-readable memory, MEM 784, for storing data 786 and at least one computer program, PROG 788, or other set of executable instructions. The eNB 782 may also include communication means such as a transmitter, TX 792, and a receiver, RX 794, for bidirectional wireless communications with one or more UEs such as UE1 702, UE2 722 and UE3 752 via at least one antenna 796.

The at least one of PROG 788 in the eNB 782 includes a set of program instructions which, when executed by the associated DP 790, enable the device to operate in accordance with the exemplary embodiments of the present invention, as detailed above. The UE1 702 also stores software 708 in its MEM 704 to implement certain exemplary embodiments of this invention. Thus, the exemplary embodiments of this invention may be implemented at least in part by computer software stored on MEM 704, 724, 754 and 784, which is executed by the DP 710 of the UE1 702 and/or by the DP 730 of the UE2 722 and/or by the DP 760 of the UE3 752 and/or by the DP 790 of eNB 782, or by hardware, or by a combination of stored software and hardware and/or firmware. Electronic devices implementing these aspects of the invention need not be the entire devices as depicted in FIGS. 1 to 5. Instead, they may be one or more components of same such as the above described stored software, hardware, firmware and DP, or a system on a chip, SoC, or an application specific integrated circuit, ASIC.

Data processor 710, 730, 760 and 790 may comprise, for example, at least one of a microprocessor, application-specific integrated chip, ASIC, field-programmable gate array, FPGA, and a microcontroller. Data processor 710, 730, 760 and 790 may comprise at least one, and in some embodiments more than one, processing core. Memory 704, 724, 754 and 784 may comprise, for example, at least one of magnetic, optical and holographic or other kind or kinds of memory. At least part of memory 704, 724, 754 and 784 may be comprised in data processor 710, 730, 760 and 790. At least part of memory 704, 724, 754 and 784 may be comprised externally to data processor 710, 730, 760 and 790.

The various embodiment of the UE1 702 can include, but are not limited to personal portable digital devices having wireless communication capabilities, including but not limited to wireless handsets, cellular telephones, navigation devices, laptop/palmtop/tablet computers, digital cameras and music devices, and Internet appliances.

Various embodiments of the computer readable MEMs 704, 724, 754 and 784 include any data storage technology type which is suitable to the local technical environment, which includes but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 710, 730, 760 and 790 include but are not limited to general purpose computers, special purpose computers, microprocessors, digital signal processors, DSPs, and multi-core processors.

As is detailed above, in one embodiment the feedback comprises a one-bit information element or a multiple bit information element, indicating at least one of whether downlink multi-user communication mode is desired or whether uplink multi-user communication mode is desired.

In another exemplary embodiment, the precoding matrix is a spatial feedback.

In another exemplary embodiment, estimating the difference between actual Eigen directions and the precoding matrix based on the received reference signal further comprises comparing the difference between actual Eigen directions and the precoding matrix to one or more predefined thresholds.

In another exemplary embodiment, the feedback further indicates a utility of the directed transmission beam.

In another exemplary embodiment, the another indication comprises a zero-forcing off-steering factor.

In another exemplary embodiment, estimating the difference between actual Eigen directions and the precoding matrix based on the received reference signal further comprises calculating a Chordal distance between the actual Eigen directions and the precoding matrix or calculating a Fubini-Study distance between the actual Eigen directions and the precoding matrix.

In another exemplary embodiment, the means for estimating the difference between actual Eigen directions and the precoding matrix based on the received reference signal further comprises means for comparing the difference between the actual Eigen directions and the precoding matrix to one or more predefined thresholds.

In another exemplary embodiment, the means for estimating the difference between the actual Eigen directions and the preco ding matrix further comprises means for calculating a Chordal distance between the actual Eigen directions and the precoding matrix or means for calculating a Fubini-Study distance between the actual Eigen directions and the precoding matrix.

In another exemplary embodiment, the reference signal is used at least for estimating difference between the actual Eigen directions and the precoding matrix, and the precoding matrix comprises spatial feedback.

It should be appreciated that the practice of the invention is not limited to the exemplary embodiments discussed here. Various modifications and adaptations to the foregoing exemplary embodiments of this invention may become apparent to those skilled in the arts in view of the foregoing description. Furthermore, some of the various features of the above non-limiting embodiments may be used to advantage without the corresponding use of other described features.

The foregoing description should therefore be considered as merely illustrative of the principles, teaching and exemplary embodiments of the present invention, and not in limitation thereof.

1-40. (canceled)

41. An apparatus, comprising:
at least one processor; and
at least one memory including computer program code,
said at least one memory and said computer program code configured, with said at least one processor, to cause said apparatus to at least:
receive a reference signal,
estimate a difference between actual Eigen directions and a precoding matrix based on the received reference signal,
generate a feedback based on the result of the estimation, and
transmit the feedback, wherein the feedback indicates at least one of the result of the estimation, whether a multi-user communication mode is desired or whether the feedback should be combined with another indication in order to determine whether a multi-user communication mode is desired.

42. The apparatus as in claim 41, wherein the precoding matrix comprises spatial feedback.

43. The apparatus as in claim 41, wherein said memory and said computer program code are further configured, with said at least one processor, to cause said apparatus to compare the difference between the actual Eigen directions and the precoding matrix to one or more predefined thresholds.

44. The apparatus as in claim 41, wherein the feedback comprises a one-bit information element or a multiple bit information element, indicating at least one of whether a downlink multi-user communication mode is desired or whether an uplink multi-user communication mode is desired.

45. The apparatus as in claim 41, wherein the feedback further indicates a utility of a directed transmission beam.

46. The apparatus as in claim 41, wherein the another indication comprises a zero-forcing off-steering factor.

47. The apparatus as in claim 41, wherein said memory and said computer program code are further configured, with said at least one processor, to cause said apparatus to calculate at least one of a Chordal distance between the actual Eigen directions and the precoding matrix or a Fubini-Study distance between the actual Eigen directions and the precoding matrix.

48. The apparatus as in claim 41, comprising at least one of a zero-forcing precoding and maximum ratio combiner receiver, a zero-forcing precoding and realistic linear minimum mean square estimator receiver, a unitary precoding and maximum ratio combiner receiver, or a unitary precoding and realistic linear minimum mean square estimator receiver.

49. A method comprising:
receiving a reference signal,
estimating a difference between actual Eigen directions and a precoding matrix based on the received reference signal,
generating a feedback based on the result of the estimation, and
transmitting the feedback, wherein the feedback indicates at least one of the result of the estimation, whether a multi-user communication mode is desired or whether the feedback should be combined with another indication in order to determine whether a multi-user communication mode is desired.

50. The method as in claim 49, wherein estimating the difference between the actual Eigen directions and the precoding matrix further comprises comparing the difference between the actual Eigen directions and the precoding matrix to one or more predefined thresholds.

51. The method as in claim 49, wherein estimating the difference between the actual Eigen directions and the precoding matrix further comprises at least one of calculating a Chordal distance between the actual Eigen directions and the precoding matrix or calculating a Fubini-Study distance between the actual Eigen directions and the precoding matrix.

52. An apparatus, comprising:
at least one processor; and
at least one memory including computer program code,
said at least one memory and said computer program code configured, with said at least one processor, to cause said apparatus to at least:
transmit a reference signal,
receive a feedback indicating at least one of a result of channel state estimation based on the transmitted reference signal, whether a multi-user communication mode is desired or whether the feedback should be combined with another indication in order to determine whether a multi-user communication mode is desired, and
determine whether to use a multi-user communication mode based on the received feedback.

53. The apparatus as in claim 52, wherein the reference signal is configured to be used at least for estimating a difference between actual Eigen directions and a precoding matrix, and the precoding matrix is a spatial feedback.

54. The apparatus as in claim 52, wherein the feedback comprises a one-bit information element or a multiple bit information element, indicating at least one of whether a downlink multi-user communication mode is desired or whether an uplink multi-user communication mode is desired.

55. The apparatus as in claim 52, wherein the feedback further indicates a utility of a directed transmission beam.

56. The apparatus as in claim 52, wherein the another indication comprises a zero-forcing off-steering factor.

57. The apparatus as in claim 53, wherein estimating the difference between the actual Eigen directions and the precoding matrix comprises at least one of calculating a Chordal distance between the actual Eigen directions and the precoding matrix or calculating a Fubini-Study distance between the actual Eigen directions and the precoding matrix.

58. A method comprising:
transmitting a reference signal,
receiving a feedback indicating at least one of a result of channel state estimation based on the transmitted reference signal, whether a multi-user communication mode is desired or whether the feedback should be combined with another indication in order to determine whether a multi-user communication mode is desired, and
determining whether to use a multi-user communication mode based on the received feedback.

59. The method as in claim 58, wherein the reference signal is configured to be used at least for estimating a difference between actual Eigen directions and a precoding matrix, and the precoding matrix is a spatial feedback.

60. The method as in claim 59, wherein estimating the difference between the actual Eigen directions and the precoding matrix further comprises at least one of calculating a Chordal distance between the actual Eigen directions and the precoding matrix or calculating a Fubini-Study distance between the actual Eigen directions and the precoding matrix.
